(19) United States
(12) Patent Application Publication
(10) Pub. No.: US 2015/0261021 A1
(43) Pub. Date: Sep. 17, 2015

(54) LIQUID CRYSTAL FILM HAVING DIFFERENT REFLECTING REGION OF LIGHT ACCORDING TO EXTERNAL ENVIRONMENT CONDITION AND METHOD FOR MANUFACTURING THE SAME

(71) Applicant: KOREA INSTITUTE OF SCIENCE AND TECHNOLOGY, Seoul (KR)

(72) Inventors: Munju GOH, Jeollabuk-do (KR); Nam Ho YOU, Daejeon (KR); Hyeonuk YEO, Jeollabuk-do (KR); Seung Hee LEE, Jeollabuk-do (KR); Young Bum HONG, Jeollabuk-do (KR)

(73) Assignee: KOREA INSTITUTE OF SCIENCE AND TECHNOLOGY, Seoul (KR)

(21) Appl. No.: 14/288,084

(22) Filed: May 27, 2014

(30) Foreign Application Priority Data
Mar. 14, 2014 (KR) 10-2014-0030374

(51) Int. Cl. G02F 1/13; B32B 37/02; B32B 37/24; B32B 38/00; C09K 19/36; C09K 19/54

(52) U.S. Cl. CPC G02F 1/132; C09K 19/36; C09K 19/542; B32B 37/24; B32B 38/0008; B32B 37/02; B32B 2037/243; B32B 2307/412; B32B 2315/00; B32B 2310/0831; B32B 2551/00

(57) ABSTRACT

Disclosed are a liquid crystal film having a reflecting region that changes spontaneously depending on variations in external temperature and light intensity, and a method for manufacturing the same. More particularly, the liquid crystal film has a reflecting region that changes into a visible ray region when the external temperature and light intensity increase and into a near infrared ray region when the external temperature and quality of light decrease.

### CROSS-REFERENCE TO RELATED APPLICATION

This application claims priority to Korean Patent Application No. 10-2014-0030374, filed on Mar. 14, 2014, and all the benefits accruing therefrom under 35 U.S.C. §119, the contents of which in its entirety are herein incorporated by reference.

### BACKGROUND

1. Field

The present disclosure relates to a liquid crystal film having a reflecting region that changes spontaneously depending on variations in external temperature and light intensity, and a method for manufacturing the same.

2. Description of the Related Art

Recently, buildings made of glass walls have increased in Korea and foreign countries. Most glass used for buildings is colored glass that is heat absorptive glass controlling incoming solar radiation simply by absorption of solar radiation. However, such colored glass allows absorption and conduction of a large amount of heat therethrough to cause an increase in glass surface temperature and warms the indoor air through convection. Further, in the winter season, the indoor heat is discharged to the exterior through such colored glass, thereby increasing heating load as shown by the problem of loss of 66% of cooling load and 92% of heating load through building windows and doors.

Therefore, a heat-shielding film is increasingly in demand as a means for improving the energy loss of a building most efficiently and economically. Particularly, many intentions have been given to heat-shielding window films capable of reducing heat load caused by sunlight for use in houses or cars. To reduce heat load caused by sunlight, it is required to protect transmission of the sun rays in the visible region or infrared region of solar light spectrum. Particularly, it is required to develop functional films capable of controlling the solar light introduced into the interior while their reflecting regions undergo a change depending on seasons.

According to the related art, special metals have been deposited on glass by using a vacuum film-forming method in order to shield infrared rays. However, such infrared ray-shielding films shield even electron waves, thereby causing radio jamming disrupting the use of mobile phones or the like. Otherwise, such infrared ray-shielding films make it impossible to use Hi-pass. In addition, such films have a low reflection ratio in a region of 400-1200 nm related with heat shielding, and shield the solar light spectrum even in the winter season having reduced external heat or sunlight to reduce the indoor temperature undesirably.

In addition, the existing functional films for controlling solar light use an indium tin oxide (ITO) thin film, resulting in an increase in cost, a need for an external power source, poor exchangeability with the existing windows and doors, and difficulty in scale-up. For example, Japanese Patent Laid-Open No. 2011-018037 discloses a transparent reflection film using a liquid crystal capable of reflecting solar light. However, such a film has a disadvantage in that it reflects solar light merely in a specific wavelength region and cannot control the radiative heat rays introduced into the interior depending on variations in external environment. Korean Patent Laid-Open No. 10-2009-0109927 discloses a smart window sheet capable of attachment/detachment. However, such a smart window sheet uses an ITO thin film, resulting in an increase in cost, requires a complicated manufacturing process, and is not amenable to mass production. Korean Patent Publication No. 10-2011-0030410 has a problem in that a separate conductive electrode layer should be used to apply electric power.

### REFERENCES

### Patent Documents

Japanese Patent Laid-Open No. 2011-018037 (2011.01.27)

Korean Patent Laid-Open No. 10-2009-0109927 (2009.10.21)

Korean Patent Laid-Open No. 10-2011-0030410 (2011.03.23)

### SUMMARY

The present disclosure is directed to providing a liquid crystal film having a reflecting region that changes spontaneously depending on variations in external temperature and light intensity, and a method for manufacturing the same. More particularly, the present disclosure is directed to providing a liquid crystal having a reflecting region that changes into a visible ray region when the external temperature and light intensity increase and into a near infrared ray region when the external temperature and quality of light decrease, and to a liquid crystal film including the same.

In one aspect, there is provided a liquid crystal film having a reflecting region that changes depending on external environment, the liquid crystal film including a liquid crystal mixture containing at least one of cholesteryl benzoate, cholesteryl nonanoate and cholesteryl oleyl carbonate, and a resin.

In another aspect, there is provided a method for manufacturing a liquid crystal film having reflecting region that changes depending on external environment, the method including: preparing a liquid crystal mixture by mixing at least one of cholesteryl benzoate, cholesteryl nonanoate and cholesteryl oleyl carbonate; and adding a resin to the liquid crystal mixture and mixing them.

The liquid crystal film disclosed herein shields or transmits heat depending on external temperature without supplying electric power. Particularly, the reflecting region of the liquid crystal film spontaneously changes into a visible ray region when the external temperature and light intensity increase, and into a near infrared ray region when the external temperature and light intensity decrease. The liquid crystal film disclosed herein needs neither ITO electrode nor driving energy, and controls radiative heat rays in response to the external environment. Therefore, the liquid crystal film shields radiative heat rays in summer to improve the energy efficiency of a building. On the other hand, in winter, the liquid crystal film utilizes radiative heat rays to improve the indoor heat transmittance. In addition, the liquid crystal film requires a simple manufacturing process, can be installed in the existing windows and doors, and is amenable to scale-up and mass production through the use of a roll-to-roll process.

Therefore, the liquid crystal film disclosed herein may be used as a heat-shielding film or a film requiring a change in color, may be applied to various fields including housing, industrial building and transportation such as cars or ships, and provides the effects of energy saving, carbon emission reduction, or the like.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 illustrates changes in liquid crystal of the liquid crystal film disclosed herein depending on variations in external environment;

FIG. 2 is a photographic image showing changes in light reflecting region of the liquid crystal mixture obtained from Example 1 according to an embodiment, depending on variations in external heat, wherein the liquid crystal mixture shows a red color (1° C.), green color (23° C.), and a blue color (70° C.), suggesting that it reflects red light, green light and blue light, respectively;

FIG. 3 shows the results of controlling the mixing ratio of liquid crystal used in Example 1 according to an embodiment, and thus controlling the range of liquid crystal temperature and that of reflecting region; and

FIG. 4 is a graph illustrating variations in light transmission of the film obtained from Example 3 according to an embodiment, as measured by UV-Vis spectrometry.

### DETAILED DESCRIPTION

Exemplary embodiments now will be described more fully hereinafter with reference to the accompanying drawings, in which exemplary embodiments are shown.

In one aspect, there is provided a liquid crystal film having a reflecting region that changes depending on external environment, the liquid crystal film including a liquid crystal mixture containing at least one of cholesteryl benzoate, cholesteryl nonanoate and cholesteryl oleyl carbonate, and a resin.

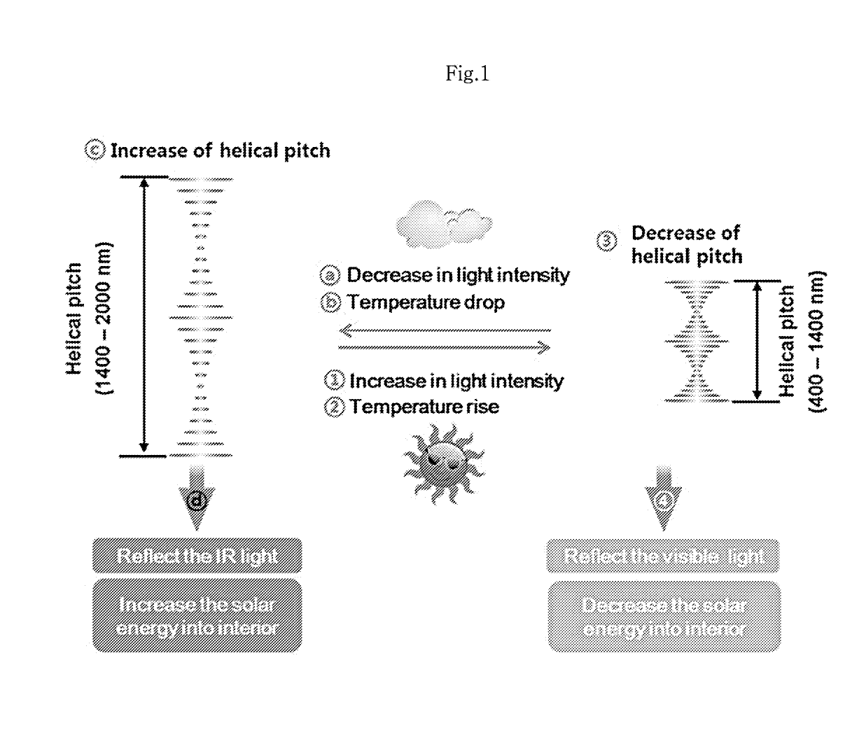

A liquid crystal is characterized by a change in its optical properties depending on external conditions such as temperature and pressure. In addition, a cholesteric derivative liquid crystal, nematic liquid crystal and cholesteric liquid crystal have different structural properties. Thus, according to some embodiments, it is possible to control the rotational direction of liquid crystal and the angle of each liquid crystal layer, i.e., twisting property of liquid crystal, upon the driving of a liquid crystal by adjusting the mixing ratio of the three different types of liquid crystals. Thus, the length of a helical pitch of liquid crystal may be controlled. In this manner, it is possible to control the reflecting region of a liquid crystal film so that it changes spontaneously to a desired extent depending on the external temperature and light intensity. Referring to FIG. 1, for example, when light intensity and temperature decrease, the helical pitch of the liquid crystal mixture increases to 1400-2000 nm. Thus, infrared rays having a wavelength of about 780-3000 nm is not transmitted but reflected, and the light having a wavelength other than the above range is transmitted, resulting in an increase in solar light introduced into the interior. On the other hand, for example, when light intensity and temperature increase, the helical pitch of the liquid crystal mixture decreases to 400-1400 nm, and not only infrared rays but also visible rays having a wavelength of about 380-780 nm are reflected, resulting in a decrease in solar light introduced into the interior.

According to some embodiments, cholesteryl benzoate, cholesteryl nonanoate and cholesteryl oleyl carbonate are represented by the following Chemical Formula 1, Chemical Formula 2 and Chemical Formula 3, respectively:

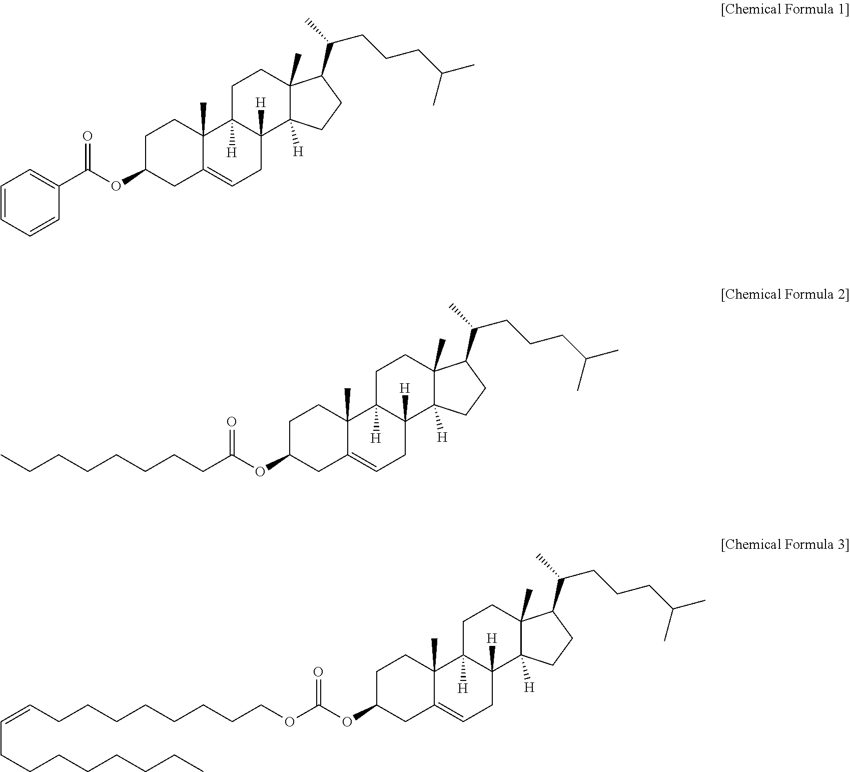

According to some embodiments, the liquid crystal mixture is a mixture containing cholesteryl benzoate, cholesteryl nonanoate and cholesteryl oleyl carbonate in a molar ratio of 1-80:100:1-60. When the mixture is in such a molar ratio, the reflecting region of the liquid crystal film may undergo a change into a visible region (about 380 nm-760 nm) when the external temperature increases, and into a near infrared region (about 750 nm-1300 nm) when the external temperature decreases.

In addition, according to some embodiments, the reflecting region may undergo a change depending on external environment when the external temperature ranges from −30° C. to 250° C.

The reflecting region of the liquid crystal film disclosed herein may be controlled depending on the external temperature and light intensity by adjusting the mixing ratio of the three materials contained in the liquid crystal mixture.

According to other embodiments, the reflecting region of the liquid crystal film may undergo a change into a visible region of 650-850 nm (red reflecting region), 450-650 nm (green reflecting region) and of 350-500 nm (blue reflecting region) sequentially as the external temperature increases. Otherwise, the reflecting region of the liquid crystal film may undergo a change into a visible region of 350-500 nm (blue reflecting region), 450-650 nm (green reflecting region) and of 650-850 nm (red reflecting region) sequentially as the external temperature decreases.

Particularly, according to an embodiment, a liquid crystal film including a liquid crystal mixture containing cholesteryl benzoate, cholesteryl nonanoate and cholesteryl oleyl carbonate in a molar ratio of 60-100:50-150:20 may undergo a change in reflecting region into a region of about 380 nm-760 nm or more when the external temperature is about −25° C. or higher. According to another embodiment, a liquid crystal film including a liquid crystal mixture containing cholesteryl benzoate, cholesteryl nonanoate and cholesteryl oleyl carbonate in a molar ratio of 10-50:100:20-60 may undergo a change in reflecting region into a region of about 380 nm-760 nm or more when the external temperature is about 25° C. or higher.

According to some embodiments, there is no particular limitation in the resin as long as it allows manufacture of a liquid crystal film and particular examples of the resin include photo-crosslinkable resin and thermally crosslinkable resin. For example, the liquid crystal mixture may include NOA 61 (Norland products, Inc.), an acrylic resin. In addition, the liquid crystal film according to an embodiment may include the liquid crystal mixture and resin in a weight ratio of 1:1-99, particularly 1:10-20.

According to some embodiments, the liquid crystal film may be formed of the liquid crystal only without any substrate. According to other embodiments, the liquid crystal film may further include a substrate. Although there is no limitation in the type of substrate, the substrate may include at least one selected from polyethylene terephthalate (PET) and glass.

In another aspect, a method for manufacturing the liquid crystal film disclosed herein includes preparing a liquid crystal mixture by mixing at least one of cholesteryl benzoate, cholesteryl nonanoate and cholesteryl oleyl carbonate, and adding a resin to the liquid crystal mixture and mixing them. Particularly, according to an embodiment, the liquid crystal mixture includes cholesteryl benzoate, cholesteryl nonanoate and cholesteryl oleyl carbonate in a molar ratio of 1-80:100:1-60.

The method disclosed herein may further include, after the operation of adding/mixing a resin to/with the liquid crystal mixture, applying the resultant mixture containing the liquid crystal mixture and the resin onto one film and applying a spacer onto another film, stacking the two films in such a manner that the surface coated with the mixture containing the liquid crystal mixture and the resin faces the surface coated with the spacer and adhering the two films to each other, and irradiating UV rays to the adhered film to carry out photocuring. Herein, according to an embodiment, the mixture containing the liquid crystal mixture and the resin with the spacer may be applied to the films by spraying, roll-to-roll, lamination, etc. Particular examples of the spacer that may be used include glass beads, acrylic beads, etc.

The examples and experiments will now be described. The following examples and experiments are for illustrative purposes only and not intended to limit the scope of the present disclosure. In addition, the following comparative examples are disclosed for comparative purposes only and should not be understood as the related art. Further, it will be understood by those skilled in the art that various changes in form and details may be made thereto without departing from the spirit and scope of the present disclosure as defined by the appended claims.

### Example 1

### Preparation of Liquid Crystal

The liquid crystal mixture contained in the liquid crystal film according to an embodiment is prepared as described hereinafter, and is determined for a change in reflecting region depending on temperature.

First, 80 mmol of cholesteryl benzoate, 100 mmol of cholesteryl nonanoate and 20 mmol of cholesteryl oleyl carbonate are mixed to provide a liquid crystal mixture.

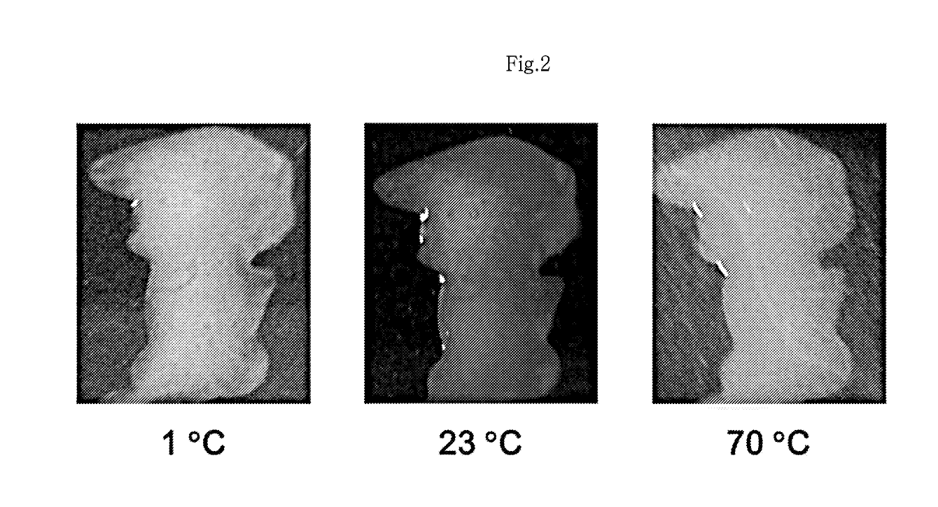

Next, the liquid crystal mixture is determined for a change in reflecting region depending on variations in external temperature by measuring the color change temperature of liquid crystal. Particularly, the liquid crystal mixture is interposed between two sheets of cover-glass, and placed on a hot stage (THMS600 Model available from Linkam). Then, a change in color is observed by the naked eyes while increasing the temperature, and the results are shown in FIG. 2. As a result, the liquid crystal mixture is transparent when the external temperature is 0° C., but reflects red light at 1° C., green light at 23° C. and blue light at 70° C. as the external temperature increases.

### Example 2

### Controlling Temperature Range of Liquid Crystal

The following experiment is carried out to determine the controllability of the light reflecting region depending on molar ratio of the three types of liquid crystals contained in the liquid crystal film according to an embodiment. The composition of each liquid crystal is shown in the following Table 1.

TABLE 1

| | Molar ratio | | |
|---|---|---|---|
| | Cholesteryl | Cholesteryl | Cholesteryl oleyl |
| | benzoate | nonanoate | carbonate |
| Ex. 2-1 | 17 | 100 | 55 |
| Ex. 2-2 | 34 | 100 | 37 |
| Ex. 2-3 | 67 | 100 | 20 |
| Ex. 2-4 | 80 | 100 | 20 |
| Ex. 2-5 | 80 | 50 | 20 |
| Ex. 2-6 | 80 | 130 | 20 |
| Ex. 2-7 | 80 | 150 | 20 |

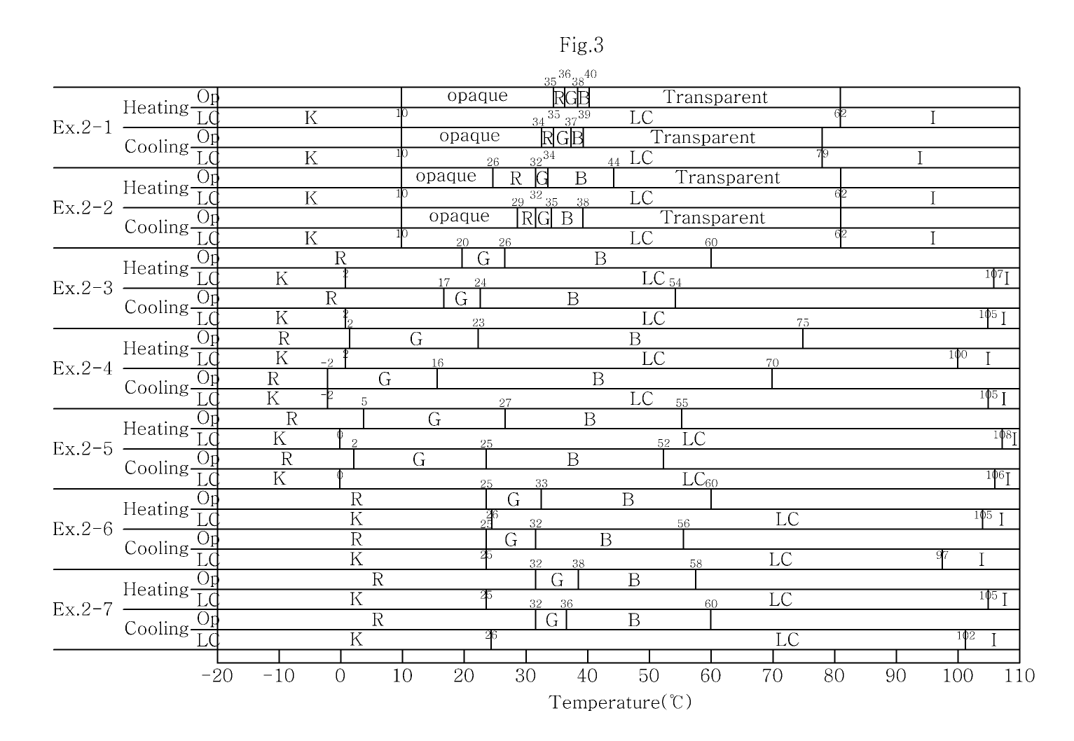

Variations in reflecting region of the liquid crystal films having the compositions as shown in Table 1 depending on temperature are shown in FIG. 3. Herein, each liquid crystal mixture is determined for a change in reflecting region depending on variations in external temperature by measuring the color change temperature of liquid crystal. Particularly, the liquid crystal mixture is interposed between two sheets of cover-glass, and placed on a hot stage (THMS600 Model available from Linkam). Then, a change in color is observed by the naked eyes while increasing the temperature, and the results are shown in FIG. 3.

As can be seen from FIG. 3, Example 2-1 and Example 2-2 containing cholesteryl benzoate, cholesteryl nonanoate and cholesteryl oleyl carbonate in a molar ratio of 10-50:100:20-60 undergo a change in reflecting region into about 380 nm-760 nm or more when the external temperature is about 25° C. or higher. It can be also seen that Example 2-3 through Example 2-7 containing cholesteryl benzoate, cholesteryl nonanoate and cholesteryl oleyl carbonate in a molar ratio of 60-100:50-150:20 undergo a change in reflecting region into about 380 nm-760 nm or more when the external temperature is about −25° C. or higher.

### Example 3

### Manufacture of Liquid Crystal Film

A liquid crystal film according to an embodiment is manufactured as described hereinafter and is determined for a change in reflecting region depending on temperature.

First, 80 mmol of cholesteryl benzoate, 100 mmol of cholesteryl nonanoate and 20 mmol of cholesteryl oleyl carbonate are mixed to provide a liquid crystal mixture, and a resin (NOA 61, Aldrich) is mixed with the liquid crystal mixture in a weight ratio of 5:100.

Then, two sheets of PET films are prepared, the mixture containing the liquid crystal mixture and the resin is dropped on one sheet and acryl beads are distributed on the other film. The two films are stacked and adhered to each other by using a press jig.

Finally, the adhered PET films are irradiated with UV rays for 1 minute to carry out photocuring, thereby providing a liquid crystal film.

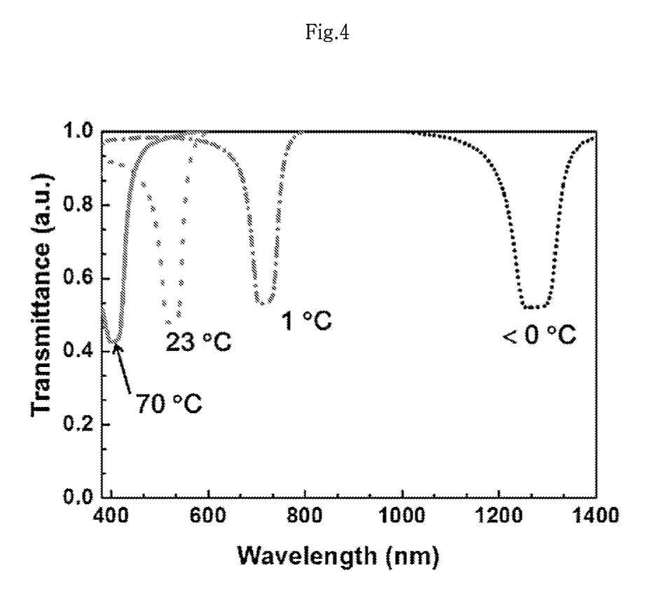

The liquid crystal film is determined for transmittance by UV-Vis spectrometry. As a result, it can be seen from FIG. 4 that the film undergoes a change in reflecting region into 650-850 nm (red reflecting region), 450-650 nm (green reflecting region) and into 350-500 nm (blue reflecting region) as the temperature increases. It can be also seen that the film undergoes a change in reflecting region into a blue reflecting region, green reflecting region and into a red reflecting region as the temperature decreases.

While the exemplary embodiments have been shown and described, it will be understood by those skilled in the art that various changes in form and details may be made thereto without departing from the spirit and scope of the present disclosure as defined by the appended claims.

What is claimed is:

1. A liquid crystal film having a reflecting region that changes depending on external environment, wherein the liquid crystal film comprising a liquid crystal mixture comprising at least one of cholesteryl benzoate, cholesteryl nonanoate and cholesteryl oleyl carbonate, and a resin.

2. The liquid crystal film having a reflecting region that changes depending on external environment according to claim 1, wherein the liquid crystal mixture is a mixture comprising cholesteryl benzoate, cholesteryl nonanoate and cholesteryl oleyl carbonate in a molar ratio of 1-80:100:1-60.

3. The liquid crystal film having a reflecting region that changes depending on external environment according to claim 1, wherein the resin is an acrylic resin.

4. The liquid crystal film having a reflecting region that changes depending on external environment according to claim 1, which comprises the liquid crystal mixture and the resin in a weight ratio of 1:1-99.

5. The liquid crystal film having a reflecting region that changes depending on external environment according to claim 1, which further comprises a substrate comprising at least one of polyethylene terephthalate (PET) and glass.

6. The liquid crystal film having a reflecting region that changes depending on external environment according to claim 1, wherein the external environment includes an external temperature ranging from −30° C. to 250° C.

7. The liquid crystal film having a reflecting region that changes depending on external environment according to claim 1, which undergoes a change in reflecting region into a visible region of 650-850 nm (red reflecting region), 450-650 nm (green reflecting region) and of 350-500 nm (blue reflecting region) sequentially as the external temperature increases, and undergoes a change into a visible region of 350-500 nm (blue reflecting region), 450-650 nm (green reflecting region) and of 650-850 nm (red reflecting region) sequentially as the external temperature decreases.

8. A method for manufacturing a liquid crystal film having a reflecting region that changes depending on external environment, the method comprising:
preparing a liquid crystal mixture by mixing at least one of cholesteryl benzoate, cholesteryl nonanoate and cholesteryl oleyl carbonate; and
adding a resin to the liquid crystal mixture and mixing them.

9. The method for manufacturing a liquid crystal film having a reflecting region that changes depending on external environment according to claim 8, which further comprises, after said adding and mixing a resin,
applying the resultant mixture comprising the liquid crystal mixture and the resin onto one film and applying a spacer onto another film;
stacking the two films in such a manner that the surface coated with the mixture comprising the liquid crystal mixture and the resin faces the surface coated with the spacer and adhering the two films to each other; and
irradiating UV rays to the adhered film to carry out photocuring.
